(19) United States
(12) Patent Application Publication
(10) Pub. No.: US 2021/0066680 A1
(43) Pub. Date: Mar. 4, 2021

(54) BATTERY CASE ASSEMBLY

(71) Applicant: Bell Textron Inc., Fort Worth, TX (US)

(72) Inventors: William Anthony Amante, Grapevine, TX (US); Joseph Richard Carpenter, JR., Kennedale, TX (US); Timothy Brian Carr, Fort Worth, TX (US)

(21) Appl. No.: 16/555,197

(22) Filed: Aug. 29, 2019

(51) Int. Cl. H01M 2/10

(52) U.S. Cl. CPC H01M 2/1077; H01M 2/1083

(57) ABSTRACT

Various implementations described herein are directed to a battery case assembly. In one implementation, the battery case assembly includes a plurality of structural beams and a chassis coupled to the plurality of structural beams. The plurality of structural beams of the battery case assembly is configured to be coupled to a portion of an aircraft frame.

### STATEMENT REGARDING FEDERALLY SPONSORED RESEARCH OR DEVELOPMENT

Not applicable.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Electrified and hybrid-electric aircraft utilize battery power to operate. The weight of the batteries that provide battery power for aircraft can be substantial. These heavy batteries can be installed in a tower within the aircraft, however, battery towers increase the total weight of the aircraft substantially and can only be installed in certain portions of the aircraft.

### SUMMARY

Described herein are various implementations of a battery case assembly. In one implementation, the battery case assembly includes a plurality of structural beams and a chassis coupled to the plurality of structural beams. The plurality of structural beams of the battery case assembly is configured to be coupled to a portion of an aircraft frame.

The portion of the aircraft frame may include a floor panel. The portion of the aircraft frame may include keel beams on a bottom portion of the aircraft frame.

The battery case assembly may be configured to be coupled to another battery case assembly in a stacked configuration.

The battery case assembly may include a cover. In one implementation, the cover can be a one-piece cover having a first side portion, a second side portion, and a top portion.

In one implementation, the cover may include a plurality of side panels and a removable top panel. The first side panel and the second side panel may include connector openings. Each of the plurality of side panels may be coupled to the plurality of structural beams.

The plurality of structural beams may include a plurality of openings that allow for coupling in a plurality of configurations. In one implementation, the battery case assembly may include a plurality of isolators coupled between the battery case assembly and the portion of the aircraft frame.

Each structural beam may include index openings. The chassis may include index openings. The structural beams and the chassis of the battery case assembly can be self-locating, e.g., during assembly, due to the index openings of the structural beams and the index openings of the chassis.

The chassis may be a machined isogrid structure. Each structural beam can be machined with attach stiffeners.

Described herein is also a method of assembling a battery case. In one implementation, a plurality of structural beams is provided. A chassis is coupled to the plurality of structural beams. The plurality of structural beams of the battery case assembly is configured to be coupled to a portion of an aircraft frame.

In one implementation, the structural beams and the chassis of the battery case assembly are self-located using index openings of the structural beams and the chassis.

Described herein is also an aircraft. In one implementation, the aircraft includes an aircraft and one or more battery case assemblies. Each battery case assembly includes a plurality of structural beams and a chassis coupled to the plurality of structural beams. The plurality of structural beams of each battery case assembly is configured to be coupled to a portion of the aircraft frame.

In one implementation, at least one of the one or more battery case assemblies acts as a ballast for the aircraft.

The above referenced summary section is provided to introduce a selection of concepts in a simplified form that are further described below in the detailed description section. Additional concepts and various other implementations are also described in the detailed description. The summary is not intended to identify key features or essential features of the claimed subject matter, nor is it intended to be used to limit the scope of the claimed subject matter, nor is it intended to limit the number of inventions described herein. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates an example battery case assembly chassis in accordance with implementations of various techniques described herein.

FIG. 2 illustrates example structural beams of a battery case assembly in accordance with implementations of various techniques described herein.

FIG. 3 illustrates a perspective view of a battery case assembly in accordance with implementations of various techniques described herein.

FIG. 4 illustrates a bottom perspective view of a battery case assembly in accordance with implementations of various techniques described herein.

FIG. 5 illustrates a perspective view of a battery case assembly in accordance with implementations of various techniques described herein.

FIG. 6 illustrates a side perspective view of an aircraft frame in accordance with implementations of various techniques described herein.

FIG. 7 illustrates a side perspective view of a front portion of an aircraft frame in accordance with implementations of various techniques described herein.

FIG. 8 illustrates a side perspective view of a rear portion of aircraft frame in accordance with implementations of various techniques described herein.

FIG. 9 illustrates a side view of a rear portion of an aircraft frame in accordance with implementations of various techniques described herein.

FIG. 10 illustrates a bottom view of aircraft frame in accordance with implementations of various techniques described herein.

FIG. 11 illustrates a bottom perspective view of aircraft frame in accordance with implementations of various techniques described herein.

FIG. 12 illustrates a block diagram of a method of assembling a battery case in accordance with implementations of various techniques described herein.

FIG. 13 illustrates a close-up of an index opening in accordance with implementations of various techniques described herein.

FIG. 14 illustrates an index opening in accordance with implementations of various techniques described herein.

FIG. 15 illustrates attach stiffeners in accordance with implementations of various techniques described herein.

### DETAILED DESCRIPTION

Described herein is a battery case assembly. The battery case assembly may be used within an aircraft frame of an aircraft. The battery case assembly includes three main structural elements: structural beams (two) and a chassis on the bottom.

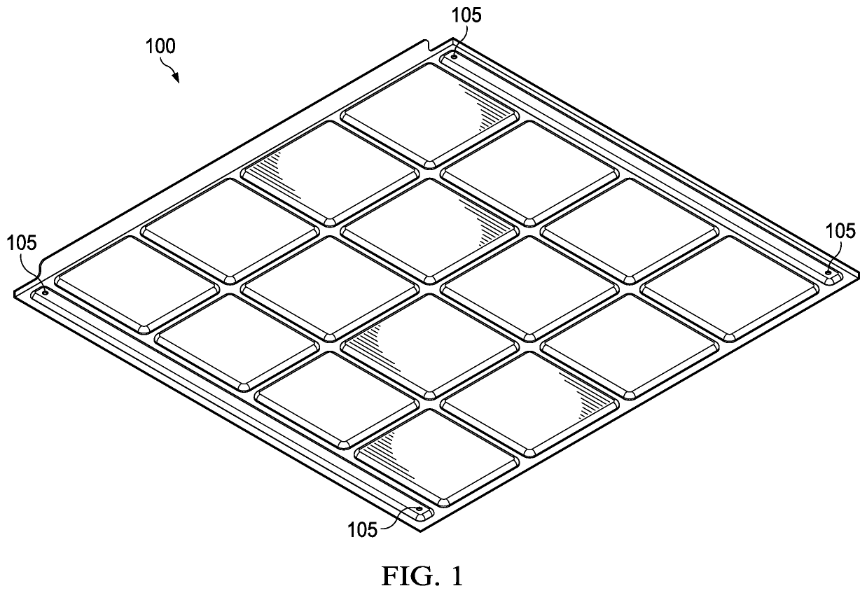

FIG. 1 illustrates an example battery case assembly chassis 100. The chassis 100 includes four index openings 105 that allow the chassis to be assembled with two structural beams (not shown) in a self-locating manner without tooling. Chassis 100 can be a machined isogrid structure. The machined isogrid structure provides higher strength and stiffness and a lower weight when compared to a similarly sized chassis that does not include the isogrid structure. FIG. 13 illustrates a close-up of an index opening 105 of chassis 100.

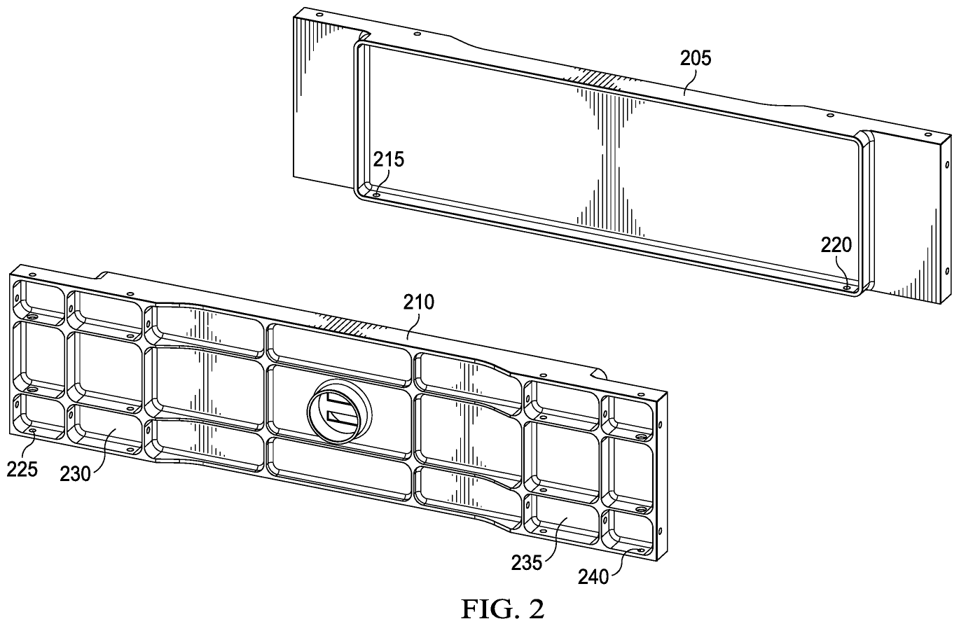

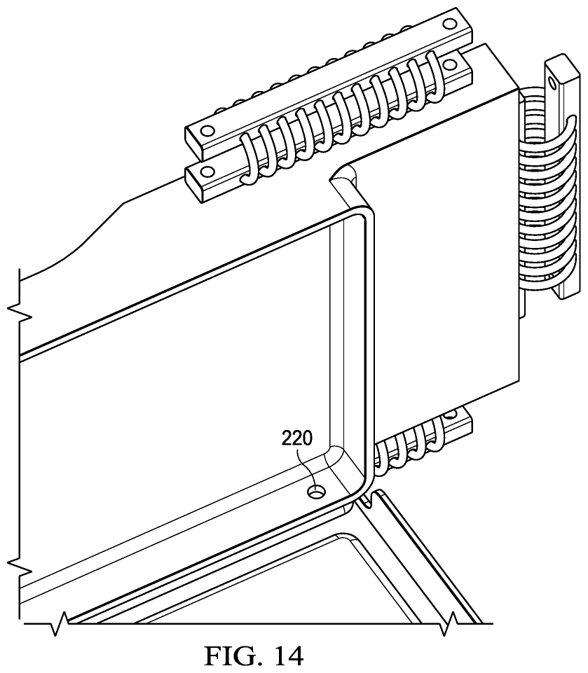

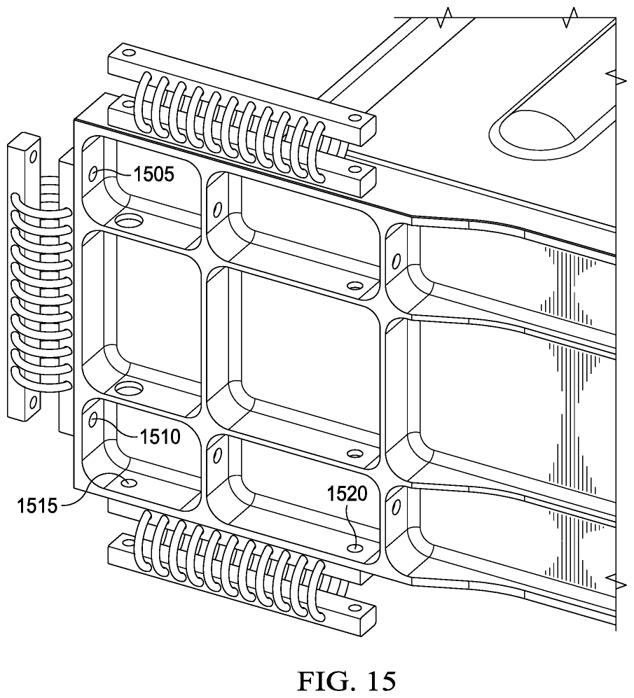

FIG. 2 illustrates example structural beams 205, 210 of a battery case assembly. Structural beam 205 includes index openings 215, 220 that allow the structural beam 205 to be coupled to the chassis 100 in a self-locating manner without tooling. Structural beam 210 also includes index openings (not shown) for coupling to chassis 100 in the same manner as structural beam 205. Structural beams 205, 210 are machined with attach stiffeners. The plurality of structural beams includes a plurality of openings 225, 230, 235, 240 that allow for coupling in a plurality of configurations. FIG. 14 illustrates index opening 220 in greater detail. FIG. 15 shows the attach stiffeners 1505, 1510, 1515, 1520 of structural beams 205, 210 in greater detail. The attach stiffeners 1505, 1510, 1515, 1520 are placed in three locations on each side of the beam to provide a plurality of options for mounting the battery case assemblies.

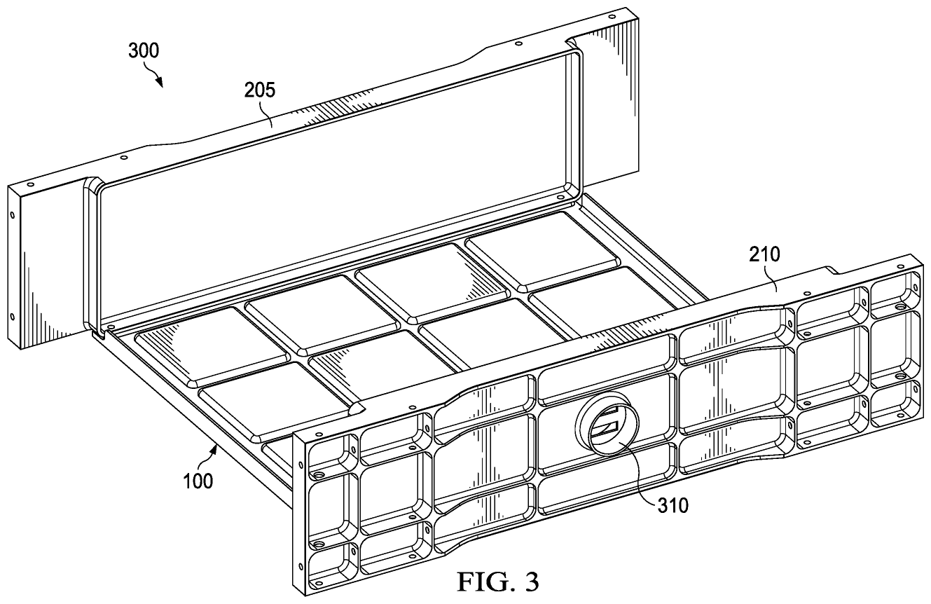

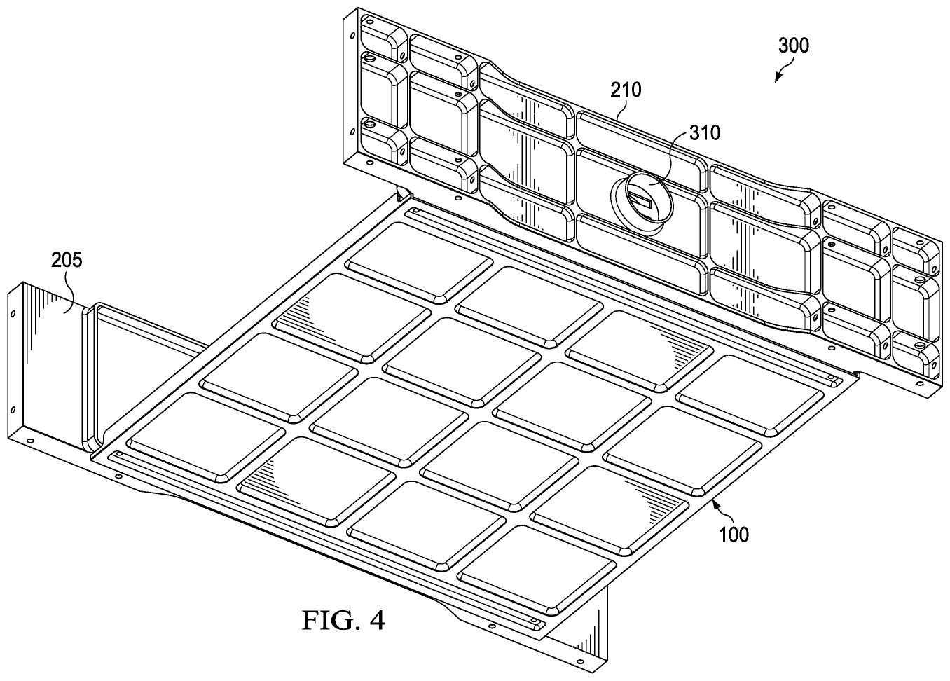

FIG. 3 illustrates a perspective view of a battery case assembly 300. FIG. 4 illustrates a bottom perspective view of battery case assembly 300. Structural beam 210 includes an exhaust opening 310. Exhaust opening 310 provides a location for heat from the battery to exit the battery case assembly in the event that the battery within the battery case assembly overheats. Although exhaust opening 310 is shown in structural beam 210, exhaust opening 310 may be included in one or both of structural beams 205, 210.

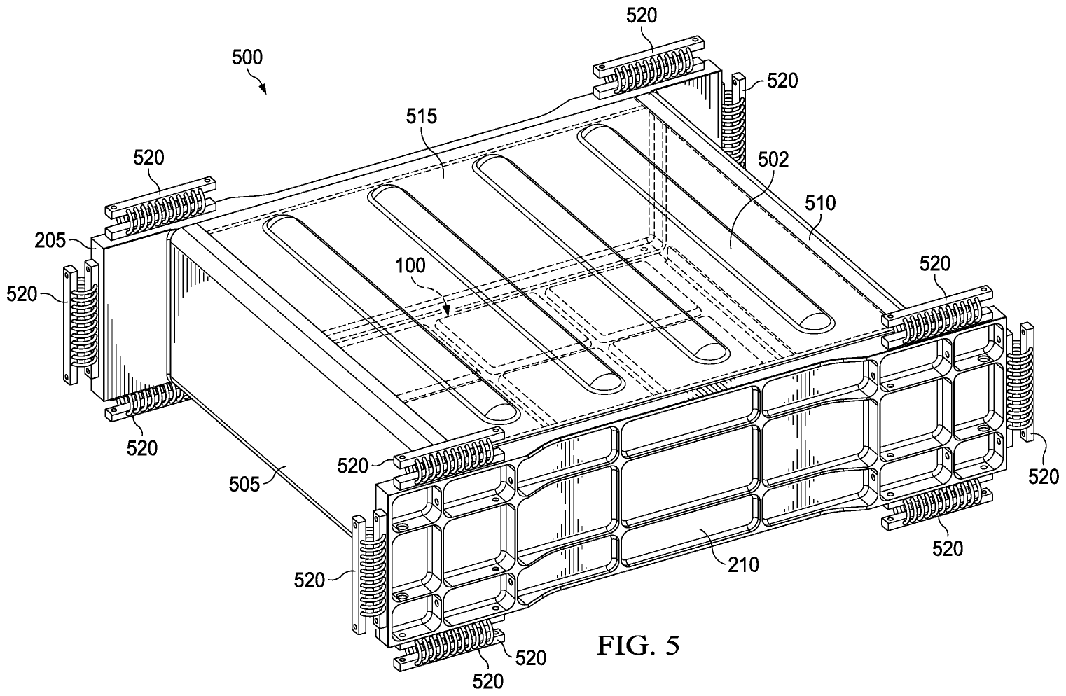

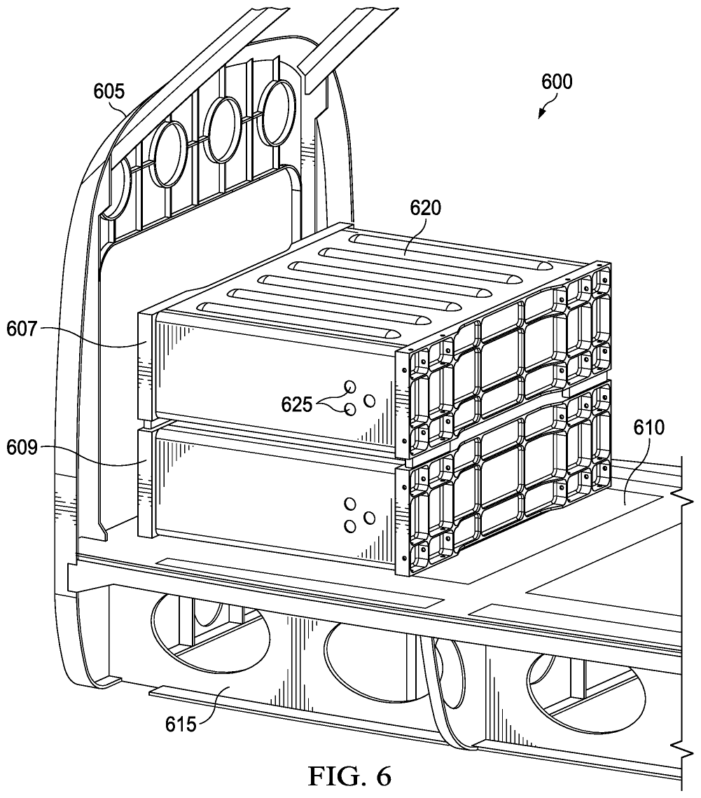

FIG. 5 illustrates a perspective view of a battery case assembly 500. Battery case assembly 500 includes the elements of battery case assembly 300 and further includes a cover 502. Cover 502 includes side panels 505, 510 and a top panel 515. Side panels 505, 510 may include connector openings (as shown in FIG. 6) for electrical connections to the battery stored within the battery case assembly 500. Cover 502 may be screwed or riveted to the structural beams 205, 210.

In one implementation, cover 502 is a one piece panel having side portions 505, 510 and a top portion 515. The side portions 505, 510 of the cover 502 are coupled to the structural beams 205, 210.

In another implementation, cover 502 is implemented as three pieces with a first side panel 505, a second side panel 510 and a top panel 515. In this implementation, the first side panel 505 and the second side panel 510 are coupled to the structural beams 205, 210 and the top panel 515 is removable.

The structural beams 205, 210 include mounts on each corner. At each corner of the battery assembly mounts, there are four openings (two arranged vertically and two arranged horizontally) that allow for mounting to the aircraft (e.g., to the floor of the airframe or the keel beam of the airframe) or to other battery assemblies. In one implementation, one opening at each corner can be used to mount the battery case assembly (e.g., if isolators are not utilized).

In one implementation, the battery case assembly may include a plurality of isolators 520 configured to be coupled between the battery case assembly and a portion of the aircraft frame (e.g., the floor or the keel beam). In certain implementations, isolators 520 may be coupled between battery case assemblies.

Isolators 520 are used to isolate the fuselage (e.g., aircraft frame) loads from the battery case assembly. In one implementation, isolators 520 can isolate fuselage loads and vibrational loads.

FIG. 6 illustrates a side perspective view of an aircraft frame 600. A front portion 605 of aircraft frame 600 includes a floor panel 610 and keel beams 615 running along a bottom portion of the aircraft frame 600. In the implementation shown in FIG. 6, battery case assemblies 607, 609 are coupled to the floor panel 610 in a stacked configuration 620. Although only two battery case assemblies 607, 609 are shown in the stacked configuration, more than two battery case assemblies may be included in the stacked configuration 620 depending on the weight and height requirements of the aircraft for the aircraft frame 600. Battery case assemblies 607, 609 include connector openings 625 as described above with respect to FIG. 5. In this implementation, openings of a bottom portion of battery case assembly 607 are coupled to openings of a top portion of battery case assembly 609. Openings of a bottom portion of battery case assembly 609 are used to couple battery case assembly 609 to floor panel 610.

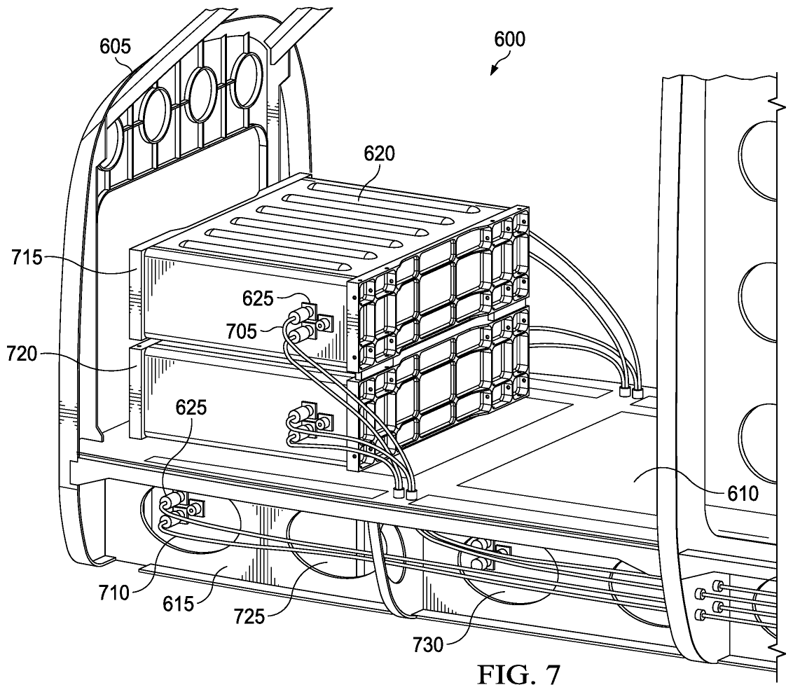

FIG. 7 illustrates a side perspective view of a front portion 605 of aircraft frame 600. FIG. 7 shows four battery case assemblies 715, 720, 725, 730 coupled to the aircraft frame 600 in different locations. The stacked configuration 620, including battery case assemblies 715, 720, is coupled to the floor 610. Connector wires 705 are coupled to the battery within the battery case assembly 500 through connector opening 625. Additional battery case assemblies 725, 730 are coupled to the keel 615. Connector wires 710 are coupled to the battery within the battery case assembly 725. In this implementation, openings of a bottom portion of battery case assembly 715 are coupled to openings of a top portion of battery case assembly 720. Openings of a bottom portion of battery case assembly 720 are used to couple battery case assembly 720 to floor panel 610. Openings of side portions of battery case assemblies 725, 730 are used to couple the battery case assemblies 725, 730 to the keel 615.

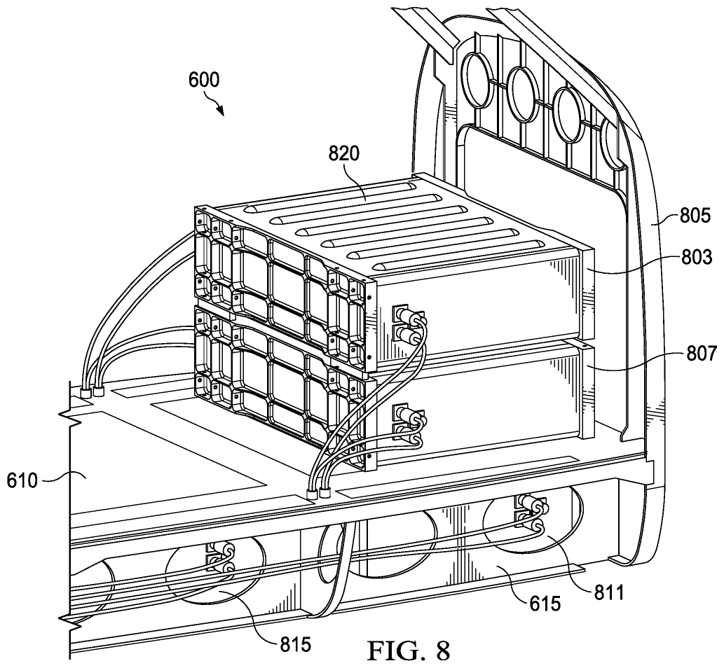

FIG. 8 illustrates a side perspective view of a rear portion 805 of aircraft frame 600. FIG. 8 shows four battery case assemblies 803, 807, 811, 815 coupled to the aircraft frame in different locations. Battery case assemblies 803, 807 are coupled to the floor 610 in a stacked configuration 820 in the rear portion 805 of the aircraft frame 600. Battery case assemblies 811, 815 are coupled to the keel 615 of the aircraft frame. In this implementation, openings of a bottom portion of battery case assembly 803 are coupled to openings of a top portion of battery case assembly 807. Openings of a bottom portion of battery case assembly 807 are used to couple battery case assembly 807 to floor panel 610. Openings of side portions of battery case assemblies 811, 815 are used to couple the battery case assemblies 811, 815 to the keel 615.

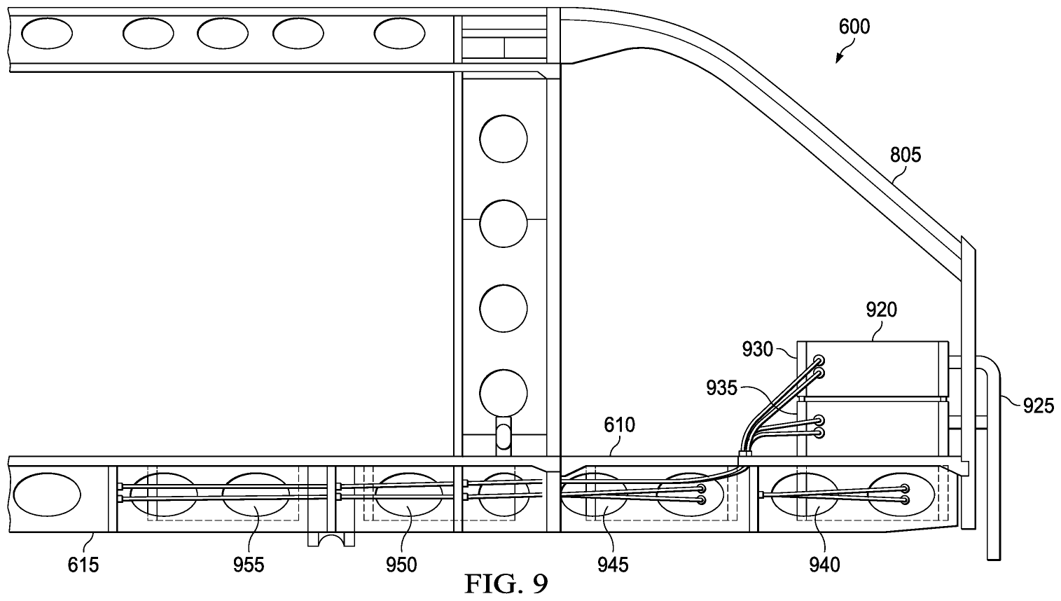

FIG. 9 illustrates a side view of a rear portion 805 of aircraft frame 600. FIG. 9 shows six battery case assemblies 930, 935, 940, 945, 950, 955 coupled to the aircraft frame in different locations. Battery case assemblies 930, 935 are coupled to the floor 610 in a stacked configuration 920 in the rear portion 805 of the aircraft frame 600. Battery case assemblies 940, 945, 950, 955 are coupled to the keel 615 of the aircraft frame 600. Battery vent 925 provides an opening for gas and hot air to escape when a battery is defective, e.g., expulsing gas and/or on fire.

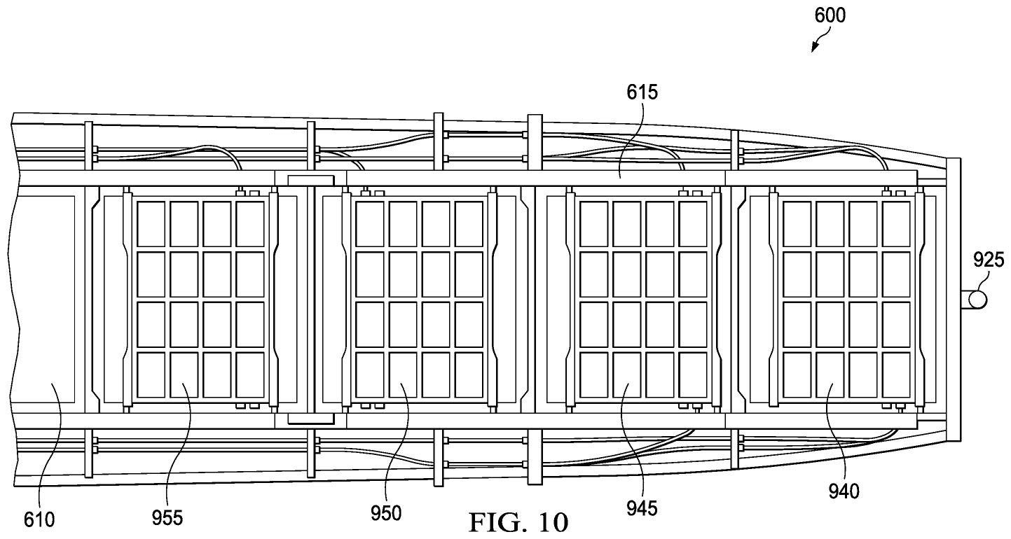

FIG. 10 illustrates a bottom view of aircraft frame 600. A bottom view of battery case assemblies 940, 945, 950, 955 coupled to keel beam 615 is shown.

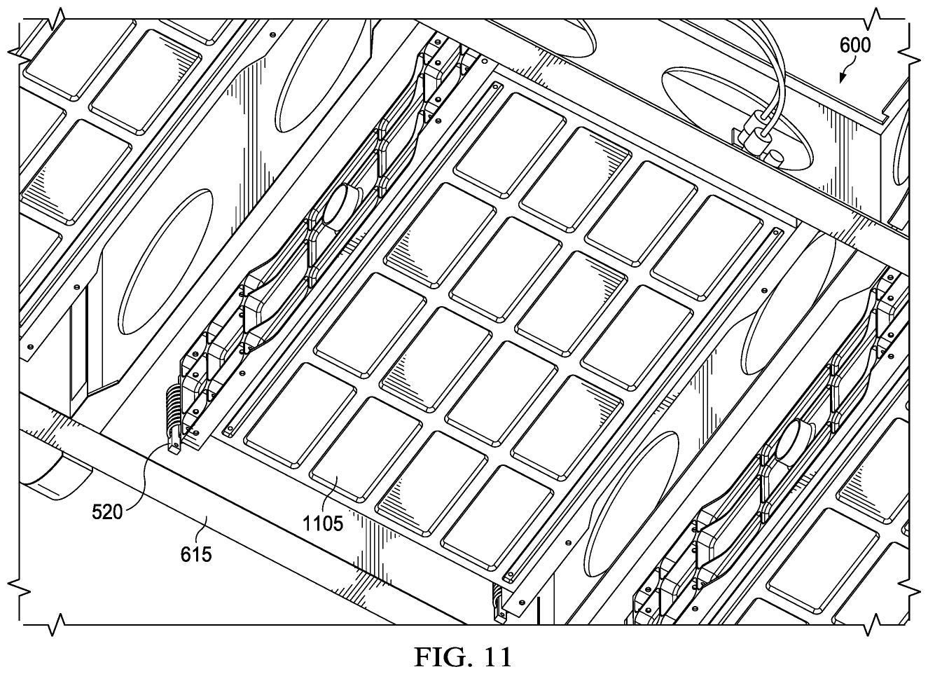

FIG. 11 illustrates a bottom perspective view of aircraft frame 600. FIG. 11 shows battery case assembly 1105 coupled to the keel 615 of aircraft frame 600 using isolators 520. In this implementation, side openings of battery case assembly 1105 are used to couple the battery case assembly to the keel beam 615.

In one implementation, a battery case assembly or battery case assemblies in a stacked configuration can serve a dual purpose of housing a battery and acting as ballast for the aircraft. Ballast is defined as removable or permanently installed weight in an aircraft that is used to bring a center of gravity of the aircraft into an allowable range. The center of gravity of the aircraft can be adjusted by coupling one or more battery case assemblies in different locations within the aircraft frame. In one implementation, to adjust the center of gravity in an unmanned aircraft, the one or more battery case assemblies acting as ballast are located toward the front of the aircraft. In another implementation, to adjust the center of gravity in aircraft that carry people, the one or more battery case assemblies can be located various locations within the aircraft.

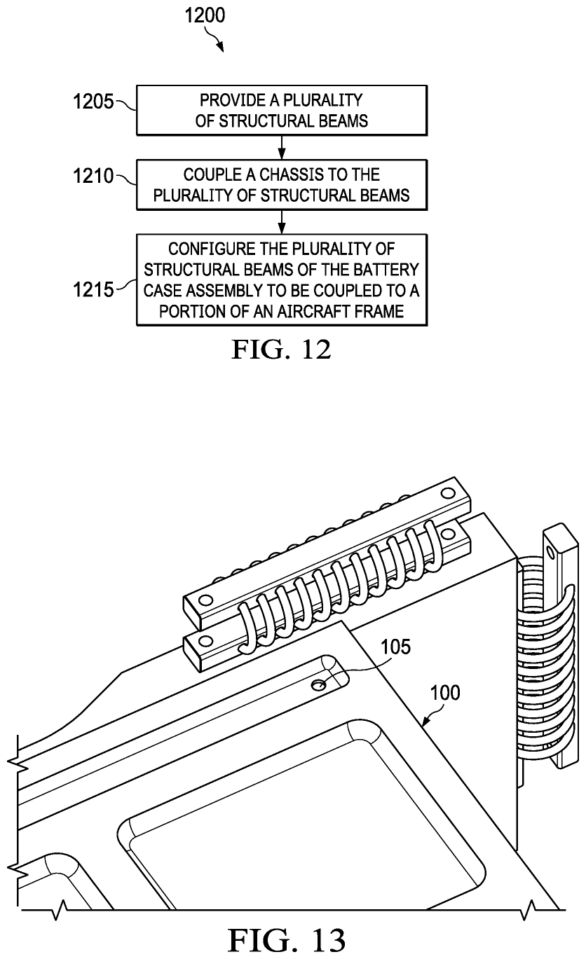

FIG. 12 illustrates a block diagram of a method 1200 of assembling a battery case. At block 1205, a plurality of structural beams is provided. At block 1210, a chassis is coupled to the plurality of structural beams. At block 1215, the plurality of structural beams of the battery case assembly is configured to be coupled to a portion of an aircraft frame.

The chassis, e.g., chassis 100, and the plurality of structural beams, e.g., structural beams 205, 210 may include index openings that allow the chassis to be assembled with the plurality of structural beams in a self-locating manner without tooling. The plurality of structural beams includes a plurality of openings, e.g., openings 225, 230, 235, 240, that allow for coupling in a plurality of configurations.

The plurality of structural beams further includes an exhaust opening that provides a location for heat from the battery to exit the battery case assembly in the event that the battery within the battery case assembly overheats.

In one implementation, assembling the battery case further includes coupling a cover, e.g., cover 502, to the battery case assembly. In one implementation, the cover is implemented as a one piece cover that is coupled to the battery case assembly. In another implementation, the cover is implemented as three pieces with a first side panel, a second side panel and a top panel. In this implementation, the first side panel and the second side panel are coupled to the plurality of structural beams and the top panel is removable.

The battery case assembly of the present disclosure provides a number of distinct advantages. Some advantages of the battery case assembly of the present disclosure are that the battery case assembly is light-weight and easy to manufacture.

In addition, the battery case assembly is modular in that coupling can occur in a variety of locations. For example, the battery case assembly can be coupled to the floor or the keel beam of an aircraft frame. The battery case assembly may also be coupled to another battery case assembly in a stacked configuration.

Further, building of additional aircraft structure is not required to house one or more batteries within the aircraft. The existing structure of the aircraft frame can be used to house batteries within the aircraft.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”, “upwardly” and downwardly“; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A battery case assembly, comprising:
a plurality of structural beams; and
a chassis coupled to the plurality of structural beams;
wherein the plurality of structural beams is configured to be coupled to a portion of an aircraft frame.

2. The battery case assembly of claim 1, wherein the portion of the aircraft frame comprises a floor panel.

3. The battery case assembly of claim 1, wherein the portion of the aircraft frame comprises keel beams on a bottom portion of the aircraft frame.

4. The battery case assembly of claim 1, wherein the battery case assembly is configured to be coupled to another battery case assembly in a stacked configuration.

5. The battery case assembly of claim 1, further comprising a cover.

6. The battery case assembly of claim 5, wherein the cover comprises a one-piece cover having a first side portion, a second side portion, and a top portion.

7. The battery case assembly of claim 5, wherein the cover comprises:
a plurality of side panels; and
a removable top panel.

8. The battery case assembly of claim 7, wherein the first side panel and the second side panel include connector openings.

9. The battery case assembly of claim 7, wherein each of the plurality of side panels is coupled to the plurality of structural beams.

10. The battery case assembly of claim 1, wherein the plurality of structural beams includes a plurality of openings that allow for coupling in a plurality of configurations.

11. The battery case assembly of claim 10, wherein the battery case assembly includes a plurality of isolators coupled between the battery case assembly and the portion of the aircraft frame.

12. The battery case assembly of claim 1, wherein each structural beam includes index openings.

13. The battery case assembly of claim 12, wherein the chassis includes index openings.

14. The battery case assembly of claim 13, wherein the plurality of structural beams and the chassis of the battery case assembly are self-locating due to the index openings of the structural beams and the index openings of the chassis.

15. The battery case assembly of claim 1, wherein the chassis comprises a machined isogrid structure.

16. The battery case assembly of claim 1, wherein each structural beam is machined with attach stiffeners.

17. A method of assembling a battery case, comprising:
providing a plurality of structural beams;
coupling a chassis to the plurality of structural beams; and
configuring the plurality of structural beams of the battery case assembly to be coupled to a portion of an aircraft frame.

18. The method of assembling a battery case of claim 17, further comprising:
self-locating the structural beams and the chassis of the battery case assembly using index openings of the structural beams and the chassis.

19. An aircraft, comprising:
an aircraft frame; and
one or more battery case assemblies, each battery case assembly, comprising:
a plurality of structural beams; and
a chassis coupled to the plurality of structural beams;
wherein the plurality of structural beams of each battery case assembly is configured to be coupled to a portion of the aircraft frame.

20. The aircraft of claim 19, wherein at least one of the one or more battery case assemblies acts as a ballast for the aircraft.
